(19) United States
(12) Patent Application Publication
(10) Pub. No.: US 2022/0188673 A1
(43) Pub. Date: Jun. 16, 2022

(54) MIXED-PRECISION AI PROCESSOR AND OPERATING METHOD THEREOF

(71) Applicant: Cvitek Co. Ltd., Beijing (CN)

(72) Inventors: Chia-Lin LU, Hsinchu City (TW); Yuan-Hsiang KUO, Hsinchu City (TW); Wei-Chun CHANG, Taoyuan City (TW); Jen-Shi WU, Zhubei City (TW); Chieh-Wen SHIH, Zhubei City (TW)

(21) Appl. No.: 17/550,982

(22) Filed: Dec. 14, 2021

(30) Foreign Application Priority Data
Dec. 14, 2020 (CN) 202011474919.6

(51) Int. Cl. G06N 5/04; G06F 9/30

(52) U.S. Cl. CPC G06N 5/04; G06F 9/30025

(57) ABSTRACT

A mixed-precision artificial intelligence (AI) processor and an operating method thereof are provided. The AI processor includes a first calculation module, a second calculation module and a control module. The first calculation module is configured to perform calculation based on the data with a first format. The second calculation module is configured to perform calculation based on the data with a second format different from the first format. The control module is coupled to the first calculation module and the second calculation module to select one of the first calculation module or the second calculation module to perform calculation based on an input data according to a calculation strategy.

This application claims the benefit of People's Republic of China application Serial No. 202011474919.6, filed Dec. 14, 2020, the subject matter of which is incorporated herein by reference.

### BACKGROUND OF THE INVENTION

### Field of the Invention

The invention relates in general to a mixed-precision artificial intelligence (Al) processor and an operating method thereof.

### Description of the Related Art

The processor for performing Al calculation normally adopts one of Int8, BF16 and FP32 as the data format. In terms of calculation precision, FP32 is the highest, BF16 is the second, and Int8 is the lowest. In terms of calculation speed (or referred as computing power), Int8 is the highest, BF16 is the second, and FP32 is the lowest. That is, it is difficult for the AI processor to meet the requirement of calculation precision and the requirement of calculation speed using one data format.

### SUMMARY OF THE INVENTION

According to one embodiment of the present invention, a mixed-precision artificial intelligence (AI) processor is provided. The AI processor includes a first calculation module, a second calculation module and a control module. The first calculation module is configured to perform calculation based on the data with a first format. The second calculation module is configured to perform calculation based on the data with a second format different from the first format. The control module is coupled to the first calculation module and the second calculation module to switch the AI processor to a first mode, a second mode or a third mode according to a calculation strategy and perform calculation based on an input data to obtain a calculation result; wherein the calculation strategy includes: the format used in each of several calculations is the first format or the second format; in the first mode, the control module enables the first calculation module to perform calculation based on the input data; in the second mode, the control module enables the second calculation module to perform calculation based on the input data; in the third mode, for each of the calculations, the control module enables the first calculation module or the second calculation mode to perform calculation based on the input data or a data derived from the input data according to the calculation strategy.

According to another embodiment of the present invention, an operating method of a mixed-precision AI processor applicable to an AI processor is provided. The operating method includes the following steps: An input data is received. The AI processor is switched to a first mode, a second mode or a third mode by a control module of the AI processor according to a calculation strategy. The calculation strategy includes: the format used in each of several calculations is a first format or a second format; in the first mode, the control module enables a first calculation module to perform the first format calculation based on the input data; in the second mode, the control module enables a second calculation module to perform the second format calculation based on the input data; and in the third mode, for each of the calculations, the control module enables the first calculation module or the second calculation mode to perform calculation based on the input data or a data derived from the input data according to the calculation strategy.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a block diagram of an AI processor according to an embodiment of the present invention.

FIG. 2 is a flowchart of an operating method of an AI processor according to an embodiment of the present invention.

FIG. 3 is a block diagram of an AI processor according to another embodiment of the present invention.

FIG. 4 is a flowchart of an operating method of an AI processor according to another embodiment of the present invention.

### DETAILED DESCRIPTION OF THE INVENTION

The principles of the structures and operations of the present invention are disclosed below with accompanying drawings.

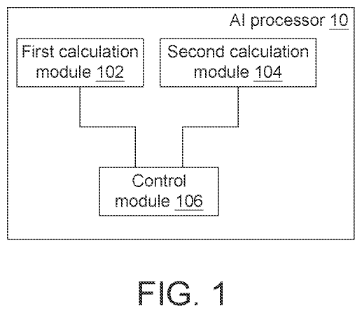

Referring to FIG. 1, a block diagram of an AI processor according to an embodiment of the present invention is shown. The AI processor 10 can be configured in an AI system to perform necessary calculations for the AI system. The AI processor 10 includes a first calculation module 102, a second calculation module 104 and a control module 106. The first calculation module 102 is coupled to the control module 106. The first calculation module 102 is configured to calculate the data with a first format. The second calculation module 104 is coupled to the control module 106. The second calculation module 104 is configured to calculate the data with a second format, which is different from the first format. The control module 106 is configured to select the first calculation module 102, the second calculation module 104 or a combination thereof according to a calculation strategy to perform calculation based on an input data to obtain a calculation result. The first format and the second format can be two of the formats Int8, BF16, and TF32, wherein Int8 represents 8-bit integer format, BF16 represents 16-bit floating-point format, and TF32 represents 19-bit floating-point format. In an embodiment, the first format is an integer format such as Int8, the second format is a floating-point format such as BF16. To put it in greater details, the AI processor 10 is provided with a first mode, a second mode and a third mode. In the first mode, the AI processor 10 selects the first calculation module 102 to perform calculation based on the input data to obtain calculation result. In the second mode, the AI processor 10 selects the second calculation module 104 to perform calculation based on the input data to obtain calculation result. In the third mode, the AI processor 10 selects a combination of the first calculation module 102 and the second calculation module 104 to perform calculation based on the input data to obtain calculation result.

The first calculation module 102 and the second calculation module 104 can be realized by two mutually independent circuits. For example, the first calculation module 102 can be realized by a first circuit, and the second calculation module 104 can be realized by a second circuit, wherein the first circuit and the second circuit can respectively include an adder, a multiplier, and a comparator configured to perform various logic operations. In an embodiment, the first circuit and the second circuit are mutually independent and are integrated on an integrated circuit chip through the layout of integrated circuit.

The control module 106 can be realized by hardware, firmware and software or a combination thereof. For example, the control module 106 can be realized by a combination of a third circuit and a decision program, the decision program determines the calculation strategy according to the input data, and determines whether to select the first mode, the second mode or the third mode to perform calculation based on the input data according to the calculation strategy. The third circuit is configured to instruct and/or select the circuit configuration of the first calculation module 102 and/or the second calculation module 104 according to the to-be-switched mode. The determination of the calculation strategy is based on the requirement of calculation speed, the requirement of calculation precision, the requirement of bandwidth, power consumption of the data, and/or a predetermined order. Specifically, in each round of decision process, the AI system needs to perform a series of “calculations”. Each “calculation” as defined in the present specification refers to a fundamental mathematical calculation such as addition, subtraction, multiplication or division, a composite convolution (product sum) formed of several fundamental mathematical calculations, or the calculation of a channel, a layer or even a network in a complicated machine learning architecture. Let object recognition of a picture performed by the AI system be taken for example. The AI system performs several rounds of filter processing on the picture to remove the background and sharpen the picture. In terms of mathematics, each filter processing can be an addition calculation, a multiplication calculation or a convolution calculation. That is, at each round of decision process during object recognition, the AI system performs a series of mathematical calculation (such as addition, multiplication, and convolution) on the input data (such as a picture); the control module 106 determines whether to select the first format or the second format to perform each calculation in the current series of calculations according to the requirement of calculation speed, the requirement of calculation precision, and the requirement of bandwidth, power consumption of the data so as to formulate the calculation strategy. For example, if the first format fits the entire series of calculations, the control module 106 switches the AI processor 10 to the first mode; if the second format fits the current series of calculations, the control module 106 switches the AI processor 10 to the second mode; if the first format fits a part of the current series of calculations and the second mode fits some other part of the current series of calculations, the control module 106 switches the AI processor 10 to the third mode. That is, the calculation decision represents the corresponding format of each calculation in the current series of calculations. For example, the current series of calculations includes a first calculation and a second calculation. The control module 106 determines to use the first format for the first calculation and use the second format for the second calculation. Thus, the calculation decision is: [the first calculation—the first format; the second calculation—the second format]. The control module 106 switches the AI processor 10 to the third mode. Moreover, when performing the first calculation, the control module 106 instructs/selects the first calculation module 102 to perform calculation; when performing the second calculation, the control module 106 instructs/selects the second calculation module 104 to perform calculation.

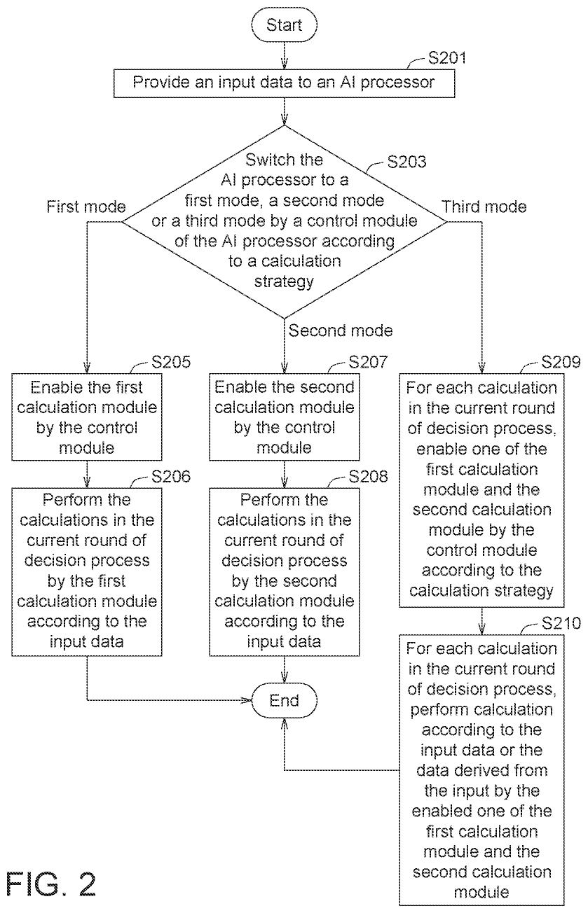

Referring to FIG. 2, a flowchart of an operating method of an AI processor according to an embodiment of the present invention is shown. The operating method of FIG. 2 can be used in the AI processor 10 of FIG. 1.

In step S201, an input data is provided to the AI processor.

In step S203, the AI processor is switched to a first mode, a second mode or a third mode by a control module of the AI processor according to a calculation strategy. The calculation strategy includes determining whether the corresponding format of each of the calculations that need to be performed in one round of decision process is the first format or the second format. In the first mode, only the first format is used for calculation; in the second mode, only the second format is used for calculation; in the third mode, a combination of the first format and the second format is sued for calculation. In the first mode, step S205 is performed; in the second mode, step S207 is performed; in the third mode, step S209 is performed.

In step S205, the first calculation module is enabled by the control module. In an embodiment, the control module further disables the second calculation module.

In step S206, the calculations in the current round of decision process are performed by the first calculation module according to the input data. In an embodiment: if the format of the input data is not the first format, the first calculation module converts the format of the input data to the first format.

In step S207, the second calculation module is enabled by the control module. In an embodiment, the control module further disables the first calculation module.

In step S208, the calculations in the current round of decision process are performed by the second calculation module according to the input data. In an embodiment: if the format of the input data is not the second format, the second calculation module converts the format of the input data to the second format.

In step S209, for each calculation in the current round of decision process, one of the first calculation module and the second calculation module is enabled by the control module according to the calculation strategy.

In step S210, for each calculation in the current round of decision process, the calculations are performed by the enabled one of the first calculation module and the second calculation module according to the input data or the data derived from the input.

The above steps relate to each calculation that the AI system needs to perform in a decision process. That is, of the calculations that the AI system needs to perform in a decision process, all of them are performed by the first calculation module 102 alone or by the second calculation module 104 alone, or a part of them are performed by the first calculation module 102 and the remaining part of them are performed by the second calculation module 104.

According to the above method, when the calculation requires high precision, the AI processor 10 can select a calculation module with high precision data format to perform calculation; for other calculation not requiring high precision, the AI processor 10 can select a calculation module with low precision data format to perform calculation. Thus, the calculation speed of the AI processor can be effectively increased and at the same time the requirement of calculation precision can be met.

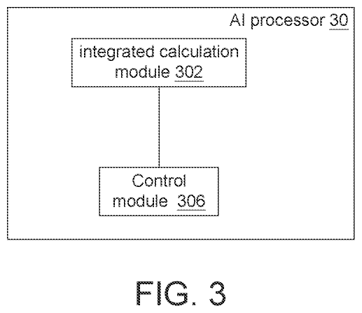

Referring to FIG. 3, a block diagram of an AI processor according to another embodiment of the present invention is shown. The AI processor 30 is configured in an AI system to perform necessary calculations for the AI system. The AI processor 30 includes an integrated calculation module 302 and a control module 306. The integrated calculation module 302 is coupled to the control module 306. The AI processor 30 is different from the AI processor 10 in that, in the AI processor 30, the first calculation module and the second calculation module are integrated as the integrated calculation module 302. The control module 306 can allocate the integrated calculation module 302 to a first configuration or a second configuration. To put it in greater details, the integrated calculation module 302 allocated to the first configuration can perform identical or similar calculations with that performed by the first calculation module 102 of the previous embodiment; the integrated calculation module 302 allocated to the second configuration can perform identical or similar calculations with that performed by the second calculation module 104 of the previous embodiment. In an embodiment, the integrated calculation module 302 can be realized by enabling the first calculation module 102 and the second calculation module 104 to share some circuit elements and by adding a switch element and/or a multiplexer thereto. The control module 306 switches the integrated calculation module 302 between the first configuration and the second configuration by sending a signal to control the switch element and/or the multiplexer and change the circuit configuration of the integrated calculation module 302.

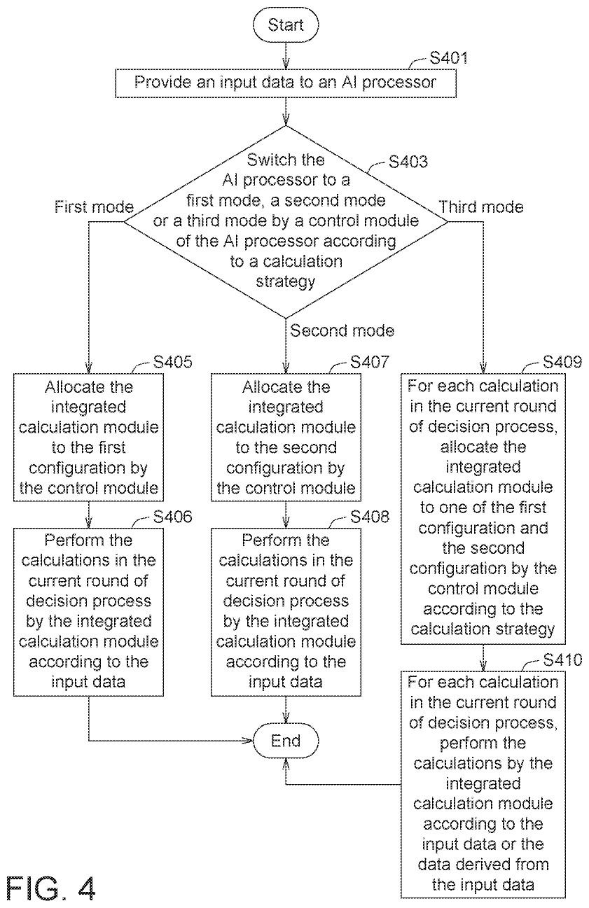

Referring to FIG. 4, a flowchart of an operating method of an AI processor according to another embodiment of the present invention is shown.

The operating method of FIG. 4 can be used in the AI processor 30 of FIG. 3.

In step S401, an input data is provided to the AI processor.

In step S403, the AI processor is switched to a first mode, a second mode or a third mode by a control module of the AI processor according to a calculation strategy, wherein the calculation strategy includes determining whether the corresponding format of each of the calculations that need to be performed in one round of decision process is the first format or the second format. In the first mode, only the first format is used for calculation; in the second mode, only the second format is used for calculation; in the third mode, a combination of the first format and the second format is used for calculation.

In the first mode S405; in the second mode, step S407 is performed; in the third mode, step S409 is performed.

In step S405, the integrated calculation module is allocated to the first configuration by the control module.

In step S406, the calculations in the current round of decision process are performed by the integrated calculation module according to the input data. In an embodiment: if the format of the input data is not the first format, the integrated calculation module converts the format of the input data to the first format.

In step S407, the integrated calculation module is allocated to the second configuration by the control module.

In step S408, the calculations in the current round of decision process are performed by the integrated calculation module according to the input data. In an embodiment: if the format of the input data is not the second format, the integrated calculation module converts the format of the input data to the second format.

In step S409, for each calculation in the current round of decision process, the integrated calculation module is allocated to one of the first configuration and the second configuration by the control module according to the calculation strategy.

In step S410, for each calculation in the current round of decision process, the calculations are performed by the integrated calculation module according to the input data or the data derived from the input data.

In step S409, the data format of the input data is converted to be identical to the data format used in one of the first mode and the second mode, the integrated calculation module is switched to be the selected one of the first mode and the second mode by the control module, and calculations are performed by the integrated calculation module according to the input data to obtain a calculation result.

In an embodiment, since the AI system may use different types of data, such as pictures and formats, in each round of decision process, a part of calculations in each round of decision process are mutual independent.

Therefore, the control module 106 306 can schedule the calculations using the first format together and schedule the calculations using the second format together. Thus, the number of times of data format conversion can be reduced and the calculation speed of the AI processor can be increased. Also, in the AI system adopting the AI processor 10 of FIG. 1, the operations of the first calculation module 102 are independent of the operations of the second calculation module 104, and the operations of the first calculation module 102 and the operations of the second calculation module 104 can therefore be performed at the same time. Thus, the calculation speed of the AI processor can be further increased.

In an experiment, the same data group and the same series of calculation are used to test several AI systems using the same Yolo_v3_416 version but adopting different AI processors. In terms of the precision (accuracy) of calculation result, the precision of the uni-precision AI processor using data format FP32 is set as the reference level, that is, 100%, the precision of the uni-precision AI processor using Int8 is 90%, the precision of the uni-precision AI processor using data format BF16 is 100%, and the precision of the mixed-precision AI processor using data formats Int8 and BF16 is 99%. In terms of efficiency (calculation speed), the efficiency of the Uni-precision AI processor using data format Int8 is set as the reference level, that is, 100%, the efficiency of the uni-precision AI processor using data format BF16 is 26%, and the efficiency of the mixed-precision AI processor using data formats Int8 and BF1 is 96%. The above experimental data shows that in comparison to the uni-precision AI processor using data format BF16, the mixed-precision AI processor using data formats Int8 and BF16 is slightly lower in terms of accuracy of calculation result (decreased to 99% from 100%), but the calculation speed is greatly increased (increased to 96% from 26%). In another experiment, the same data group and the same series of calculation are used to test several AI systems using the same mobilenet_v1_0.25 version but adopting different AI processors. In In terms of precision (accuracy) of calculation result, the precision of the uni-precision AI processor using data format FP32 is set as the reference level 100%, the precision of the uni-precision AI processor using data format Int8 is 85.8%, the precision of the uni-precision AI processor using data format BF16 is 97.6%, and the precision of the mixed precision AI processor using data formats Int8 and BF16 is 96.1%, wherein the calculation amount of the AI processor using data format BF16 amounts to 15% of the calculation amount of the mixed precision AI processor using data formats Int8 and BF16. In terms of efficiency (calculation speed), the efficiency of the uni-precision AI processor using data format Int8 is set as the reference level, that is, 100%, the efficiency of the uni-precision AI processor using data format BF16 is 50%, and the efficiency of the mixed precision AI processor using data formats Int8 and BF16 is 69%, wherein the calculation amount of the AI processor using data format BF16 amounts to 15% of the calculation amount of the mixed precision AI processor using data formats Int8 and BF16. The above experimental data shows that in comparison to the uni-precision AI processor using data format BF16, the mixed-precision AI processor using data formats Int8 and BF16 is slightly lower in terms of accuracy of calculation result (decreased to 96.1% from 97.6%), but the calculation speed is greatly increased (increased to 69% from 50%).

To summarize, the mixed-precision AI processor of the present invention can select the most suitable one among three modes (the pure integer mode, the pure floating-point mode, and the integer floating-point mixed mode) to preform calculations according to actual requirements of efficiency and precision. In comparison to the uni-precision AI processor, the mixed-precision AI processor of the present invention is more flexible and fits actual needs better.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mixed-precision artificial intelligence (AI) processor, characterized in comprising:
a first calculation module configured to perform calculation based on the data with a first format;
a second calculation module configured to perform calculation based on the data with a second format different from the first format;
a control module coupled to the first calculation module and the second calculation module to switch the AI processor to a first mode, a second mode or a third mode according to a calculation strategy and to perform calculation based on an input data to obtain a calculation result;
wherein the calculation strategy comprises: the format used in each of several calculations is the first format or the second format; in the first mode, the control module enables the first calculation module to perform calculation based on the input data; in the second mode, the control module enables the second calculation module to perform calculation based on the input data; in the third mode, for each of the calculations, the control module enables the first calculation module or the second calculation mode to perform calculation based on the input data or a data derived from the input data according to the calculation strategy.

2. The AI processor according to claim 1, wherein the first calculation module and the second calculation module are further configured to determine whether a data format of the input data is identical to the first format or the second format used in the first calculation module or the second calculation module: if the data format is different from the first format or the second format of the input data, the data format of the input data is converted to the first format or the second format used in the first calculation module or the second calculation module.

3. The AI processor according to claim 1, wherein the determination of the calculation strategy is based on the requirement of calculation speed, the requirement of calculation precision, and the requirement of bandwidth and/or power consumption of the data.

4. The AI processor according to claim 1, wherein the first format is Int8; the second format is BF16 or TF32.

5. The AI processor according to claim 1, wherein the control module can be realized by hardware, firmware and software or a combination thereof.

6. An operating method of a mixed-precision AI processor, wherein the operating method is applicable to an AI processor and is characterized in comprising:
receiving an input data; and
switching the AI processor to a first mode, a second mode or a third mode by a control module of the AI processor according to a calculation strategy, wherein the calculation strategy comprises: the format used in each of several calculations is a first format or a second format;
in the first mode, the control module enables a first calculation module to perform the first format calculation based on the input data;
in the second mode, the control module enables a second calculation module to perform the second format calculation based on the input data; and
in the third mode, for each of the calculations, the control module enables the first calculation module or the second calculation mode to perform calculation based on the input data or a data derived from the input data according to the calculation strategy.

7. The operating method according to claim 6, wherein the operating method further comprises:
determining, by the first calculation module or the second calculation module, whether a data format of the input data is identical to the first format or the second format used in the first calculation module or the second calculation module: if the data format is different from the first format or the second format used in the first calculation module or the second calculation module, converting the data format of the input data to the first format or the second format used in the first calculation module or the second calculation module.

8. The operating method according to claim 6, wherein the determination of the calculation strategy is based on the requirement of calculation speed, the requirement of calculation precision, and the requirement of bandwidth and/or power consumption of the data.

9. The operating method according to claim 6, wherein the control module can be realized by hardware, firmware and software or a combination thereof.

10. The operating method according to claim 6, wherein the first format is Int8; the second format is BF16 or TF32.

11. A mixed-precision artificial intelligence (AI) processor, characterized in comprising:
an integrated calculation module provided with a first configuration and a second configuration, wherein in the first configuration, the integrated calculation module is configured to perform calculation based on the data with a first format; in the second configuration, the integrated calculation module is configured to perform calculation based on the data with a second format different from the first format;
a control module coupled to the integrated calculation module to convert the AI processor to a first mode, a second mode or a third mode according to a calculation strategy and to perform calculation based on an input data to obtain a calculation result;
wherein the calculation strategy comprises: the format used in each of several calculations is the first format or the second format; in the first mode, the control module configures the integrated calculation module as the first configuration to perform calculation based on the input data; in the second mode, the control module configures the integrated calculation module as the second configuration to perform calculation based on the input data; in the third mode, for each of the calculations, the control module configures the integrated calculation module as the first configuration or the second configuration to perform calculation based on the input data or a data derived from the input data according to the calculation strategy.

12. The AI processor according to claim 11, wherein the integrated calculation module is further configured to determine whether a data format of the input data is identical to the first format or the second format used in the first configuration or the second configuration to which the integrated calculation module is allocated: if the data format is different from the first format or the second format used in the first configuration or the second configuration to which the integrated calculation module is allocated, the data format of the input data is converted to the first format or the second format used in the integrated calculation module.

13. The AI processor according to claim 11, wherein the determination of the calculation strategy is based on the requirement of calculation speed, the requirement of calculation precision, and the requirement of bandwidth and/or power consumption of the data.

14. The AI processor according to claim 11, wherein the first format is Int8; the second format is BF16 or TF32.

15. The AI processor according to claim 11, wherein the control module can be realized by hardware, firmware and software or a combination thereof.

16. An operating method of a mixed-precision AI processor, is applicable to an AI processor, wherein the operating method comprises:
receiving an input data; and
switching the AI processor to a first mode, a second mode or a third mode by a control module of the AI processor according to a calculation strategy, wherein the calculation strategy comprises the format used in each of several calculations is a first format or a second format;
in the first mode, the control module arranges an integrated calculation module as a first configuration to perform calculation based on the input data with the first format;
in the second mode, the control module configuration the integrated calculation module is a second configuration to perform calculation based on the input data with the second format; and
in the third mode, for each of the calculations, the control module, according to the calculation strategy, configures the integrated calculation module as the first configuration or the second configuration to perform calculation based on the input data or a data derived from the input data using the first format or the second format.

17. The operating method according to claim 16, wherein the operating method further comprises:
the integrated calculation module is further configured to determine whether a data format of the input data is identical to the first format or the second format used in the first configuration or the second configuration to which the integrated calculation module is allocated: if the data format is different from the first format or the second format used in the first configuration or the second configuration to which the integrated calculation module is allocated, the data format of the input data is converted to the first format or the second format used in the integrated calculation module.

18. The operating method according to claim 16, wherein the determination of the calculation strategy is based on the requirement of calculation speed, the requirement of calculation precision, and the requirement of bandwidth and/or power consumption of the data.

19. The operating method according to claim 16, wherein the control module can be realized by hardware, firmware and software or a combination thereof.

20. The operating method according to claim 16, wherein the first format is Int8; the second format is BF16 or TF32.
